(19) United States
(12) Patent Application Publication
(10) Pub. No.: US 2010/0100587 A1
(43) Pub. Date: Apr. 22, 2010

(54) SYSTEMS AND METHODS FOR A DATA MANAGEMENT RECOVERY IN A PEER-TO-PEER NETWORK

(75) Inventors: STEPHEN MICHAEL TEGLOVIC, SAMMAMISH, WA (US); STEVEN ALLEN HULL, SNOQUALMIE, WA (US)

Correspondence Address: MERCHANT & GOULD PC, P.O. BOX 2903, MINNEAPOLIS, MN, 55402-0903, US

(73) Assignee: DIGITAL LIFEBOAT, INC., Sammamish, WA (US)

(21) Appl. No.: 12/579,208

(22) Filed: Oct. 14, 2009

Related U.S. Application Data
(60) Provisional application No. 61/105,371, filed on Oct. 14, 2008.

(51) Int. Cl. G06F 15/16

(52) U.S. Cl. 709/203; 709/217

(57) ABSTRACT

Data Protection Services (DPS) can protect stored device resources and can ensure that a device's normal usages are not degraded or impinged while in use. Additionally, DPS can protect a user of the device from any and all complexities associated with joining a network and utilizing the network's storage capability (e.g., via Remote Storage Technology). DPS also can insure that a device joining the network can be self configured and that the relationship and\or utilization of a device's resources can be handled without burdening a user with additional associated decisions and configurations. Essentially, the DPS technology resident on a device, can automatically connect the device to a network and allow the device to operate in a manner that a typical user would not be confused by.

### CROSS REFERENCE TO RELATED APPLICATIONS

This application claims benefit of priority under 35 U.S. 119(e) to U.S. Provisional Application No. 61/105,371, filed Oct. 14, 2008, and incorporated herein by reference.

### BACKGROUND OF THE INVENTION

A significant attribute of software and/or application services operating over a Peer to Peer (P2P) network of computing devices is the ability of a particular service to marshal, direct, manage, secure, and/or utilize the cumulative resources of participating devices in the P2P network. A P2P network can utilize diverse connectivity between participants of the network along with the cumulative bandwidth of the network participants, opposed to conventional centralized network resources where a relatively low number of network server devices provide the core resources to a particular service or application. The P2P network concept is described in the first Internet Request for Comments, RFC I, “Host Software”, dated Apr. 7, 1969 (http://tools.ietf.org/html/rfel).

P2P networks can be utilized for connecting nodes (e.g., network computing devices) via largely ad hoc connections. These ad hoc connections in P2P networks are useful for many purposes, including sharing data content files containing audio, video, or any other digital data format. For example, real-time data related to telephony traffic can be transferred to a network participant utilizing P2P technology.

A pure P2P network does not have the notion of clients or servers, but instead, only equal peer nodes that can simultaneously function as both “clients” and “servers” to other nodes on the network. This model of a network arrangement differs from the traditional client-server model, where communication is directed to and from a central server. A typical example of a file transfer control device that is not P2P is a FTP server. The role of the FTP server and the role of a client device are quite distinct. For example, a client device can initiate a download or upload request from an FTP server, and the FTP server can respond by transferring the requested data.

Various network applications and channels such as Napster™, OpenNAP™, and TRC server channels use a client-server structure for some tasks (e.g., searching) and a P2P structure for others (e.g., P2P data transfer). Networks such as Gnutella™ or Freenet™ use a P2P structure for all tasks, and are sometimes referred to as true P2P networks, although Gnutella™ is greatly facilitated by directory servers that merely inform peers of the network addresses of other peers. More recently, P2P networks have achieved public recognition in the context of an absence of central indexing servers in architectures used for exchanging multimedia files (See http://en.wikipedia.org/wiki/Peer_to_peer).

At present, there are also many different services available for data backup and recovery. Many provide network solutions, where a server computer provides various data recovery services to a client computer over a network. Data backup in this context generally refers to a server storing copies of data so that the additional copies may be used to restore the original data after a data loss event. Backups are useful for disaster recovery, accidental deletion, data corruption, data migration, etc. Unfortunately, as backup systems require complete copies of data, data storage requirements can be considerable. Further, organizing this storage space and managing the backup process is a complicated process. There are also many other concerns which make traditional data backup systems difficult to effectively and affordably implement. (See http://en.wikipedia.org/wiki/Backup).

Therefore, it would be advantageous to have a robust data backup system that can provide all the crucial functions and duties of a centralized backup system but that can further take advantage of the available resources of a P2P network to improve the reliability, efficiency, and operation costs associated with the data backup system. These available P2P resources include diversified disk space, increased network bandwidth, improved CPU clock cycles, and increased system memory. Additionally, these P2P resources include advantageous nonphysical attributes, such as the ability to operate autonomously and to create or discover new solutions to enhance the system and increase overall efficiency and services in real time.

### BRIEF DESCRIPTION OF THE DRAWINGS

The accompanying drawings, which are incorporated in and constitute a part of this disclosure, illustrate various embodiments of the present invention. In the drawings:

FIG. 1 shows a PTP network with a Control Server;

FIG. 2 illustrates services associated with a Control Server;

FIG. 3 shows a Control Server Table Structure;

FIG. 4 illustrates Client Side Services;

FIG. 5 shows an Explorer Extension;

FIG. 6 illustrates a Logs view;

FIG. 7 illustrates a Progress view;

FIG. 8 shows an exemplary ProtectedFiles Table Structure;

FIG. 9 illustrates a Backup Database Model for Tracking Remote Machine Storage;

FIG. 10 shows an example Package structure;

FIG. 11 illustrates an Example Manifest;

FIG. 12 shows Content Files are Erasure Coded;

FIG. 13 illustrates example Metadata file;

FIG. 14 shows a schema;

FIG. 15 shows a schema;

FIG. 16 shows a schema;

FIG. 17 illustrates an overall system process;

FIG. 18 shows a table that contains information to initiate and/or terminate a peer job;

FIG. 19 illustrates cloud usage;

FIG. 20 shows protected file types;

FIG. 21 illustrates a cloud space;

FIG. 22 shows machine status;

FIG. 23 illustrates cloud health;

FIG. 24 shows new, trial and canceled users over time;

FIG. 25 illustrates online minutes; and

FIG. 26 shows redundancy factor;

### DETAILED DESCRIPTION

The present invention provides for systems and methods that protect, manage, and simplify a consumer's digital devices. The invention facilitates data recovery, data migration, and device recovery, along with providing other advantageous management and protective services. In various embodiments, the digital devices being protected and/or managed can include desktop computers, server computers, laptops, game consoles, mobile communications devices, navigation devices, vehicle computers, etc.

In accordance with an embodiment of the invention, Data Protection Services (DPS) can protect stored device resources and can ensure that a device's normal usages are not degraded or impinged while in use. Additionally, DPS can protect a user of the device from any and all complexities associated with joining a network and utilizing the network's storage capability (e.g., via Remote Storage Technology). DPS also can insure that a device joining the network can be self configured and that the relationship and/or utilization of a device's resources can be handled without burdening a user with additional associated decisions and configurations. Essentially, the DPS technology resident on a device, can automatically connect the device to a network and allow the device to operate in a manner that a typical user would not be confused by.

Embodiments of the present invention facilitate solutions associated with, but not limited to, at least the following three DPS Services:
Data Recovery: At least 20% of PC hard drives fail over the life of a PC. Systems and methods of the present invention allow a user to recover critical data after a failed hard drive or some other catastrophic event.
Data Migration: Most computer users replace their PC every 3.5 years. It is usually a difficult and painful process to migrate PC configuration data, user files, and installed applications from an old machine to a new machine. This data can include email setup information, web browser favorites and/or settings information, various desktop settings (e.g., screensavers, backgrounds, icons, and/or fonts), digital collection of music or pictures, installed applications such as Microsoft™ Office or Adobe™ etc. Systems and methods of the present invention allow a user to recover personalized configuration data, user generated files, and installed applications to a new PC with minimal effort. Further, embodiments of the present invention allow for migration of data from devices, such as cell phones and/or MP3 players, to newer or different device models.
Device Recovery: Roughly 15% of laptop computers are stolen each year. The number of iPods™, cellular phones, and other digital devices is even larger. Systems and methods of the present invention allow a user to report their computer or other device stolen and to remotely trigger certain monitoring and data destruction activities on the stolen devices, so that the next time the device goes online critical user data can be automatically destroyed and the stolen device can be monitored. Further, these remotely triggered services can report where the stolen computer is/was being used and provide information captured about whom is using it. The remotely triggered services can also be directed to render a stolen device unusable once the all other tasks have been completed.

In accordance with an embodiment of the invention, Remote Storage Technology (RST) can effectively manage storage and/or communication between devices in a network. RST can provide for methods, processes, and procedures that utilize and/or manage physical storage resources on a network device. Utilizing RST, information stored on a network device is secure, hidden, and immutable within the network. In an embodiment, RST storage functionality does not interfere with a device's own storage needs. With RST, device files can be compressed and/or decompressed, encrypted and/or decrypted, split and/or stitched, erasure coded and/or decoded, packed and/or unpacked, and/or transferred in such a way as to maximize file recovery, availability, and redundancy.

In various embodiments, RST compatible protocols can allow devices in a network to communicate and transfer file fragments in an efficient and secure manner The present invention provides adequate security to protect file fragments being stored on devices or being transferred between devices within the network.

In accordance with an embodiment of the invention, Cloud Management Technology (CMT) can effectively monitor and/or manage all devices in a cloud to maintain healthy and efficient services. In this context, a cloud can be a group of peers in a P2P network having portions of data pertaining to at least one complete data file. CMT functionality is important because devices of a cloud have only a local view of the network system and cannot independently determine what is happening at a global level.

In an embodiment, CMT can monitor key performance metrics to determine which devices are functioning in a reasonable and consistent manner within a network. CMT can further aggregate critical information about a cloud, monitoring it continuously for overall health and/or efficiency, providing alarms and/or alerts when corrective action is necessary. CMT can also automatically facilitate corrective action via self-healing technology or in combination with human management and/or decision making to ensure a cloud is functioning properly.

In various embodiments, CMT compatible protocols can allow Cloud Jobs functions to query the current state of devices within a cloud, synchronize information, and self-heal cloud devices. In an embodiment, Cloud Jobs functions can act independently and/or dependently as well as synchronously and/or asynchronously in accordance with the following four Cloud Jobs management types: independent/synch, independent/async, dependent/synch, and dependent/asynch. In an embodiment, job models can allow server to device, device to device, and device to server communication.

In accordance with an embodiment of the invention, Device Tracking Service (DTS) can serve a dual purpose of deleting private information from a device that is lost or stolen, while also helping to gather information that can assist in tracking the location of that device. DTS can provide for methods, processes, and procedures that identify lost or stolen devices which have been connected to the Internet. In an embodiment, once these devices are detected, DTS can secure and/or delete all user data and then continue to utilize CMT technologies to facilitate directives regarding tracking and recovery of the detected device.

In accordance with an embodiment of the invention, Device Migration Technology (DMT) can prepare every network device's data for migration to new devices. In an embodiment, this can includes all user generated data, all purchased and. installed software, and all user or system created configurations. In an embodiment, DMT can facilitate processes and methods that configure new devices to work with the data from older devices.

The present invention utilizes various technologies and services that harnesses the power of idle electronic devices (including computers) and/or extra space that exists on hard drives all over the world (e.g., in a Peer to Peer (P2P) network). By using resources already present on a network, cost to deliver and/or maintain the above services can be significantly reduced. This technology can also create a networked user community interested in protecting their own computer as well as other computers on the networks.

The present invention can utilize a number of systems and methods that orchestrate highly complex tasks of housekeeping amongst all the devices in a system. These housekeeping tasks can insure that file chunks are spread out to optimize availability and reliability as well as protect the local computational power and performance of each end node and its use by the owner.

In embodiments, various business models, processes, and/methods can be used in conjunction with the technologies and services of the present invention. These business applications can provide unique protections for service clientele, regarding protection and/or management of their devices. In embodiments, these applications can allow for premium and/or deductable pricing structures for various data protection services.

In an exemplary embodiment, a given customer of a data service may purchase backup and/or disaster recovery services by paying a moderate data protection premium. In this embodiment, if the customer requests a recovery of data from the service, the deductable can be charged according to a predetermined pricing structure for the recovery of data. In an embodiment, data protection insurance can be offered to clientele of a data protection service, such that an insurance provider can cover associated data recovery and/or management costs corresponding to a data loss or recovery event for a member of a data insurance policy.

### Compatible Systems

Operating systems compatible with embodiments of the present invention can include, but are not limited to, the following:

Windows XP, SP2 or greater

Windows Communication Foundation

Microsoft NET Framework 3.5 or greater

### Data Recovery

Data recovery associated with various embodiments of the present invention can include, but are not limited to, backup of the following data:

Backup of personalized user data, settings, and configurations

Backup of FAT, NTFS file systems

Backup local and/or attached hard drives

These data recovery solutions require minimal setup and/or configuration by a user, offer easy-to-use user interfaces, provide for full backup of complete copies of individual data files, and facilitate advanced configurations settings allowing a user to fully customize a recovery process.

### Service Oriented Architecture

Embodiments of the present invention can operate with service oriented architecture (SOA). Under this exemplary architecture, a service can be defined as a large, intrinsically unassociated unit of functionality. A service in this schema does not rely on another service to achieve an outcome and an application can orchestrate the use of various services to achieve a specific functionality. The key to SOA is the use of messaging to orchestrate a use of services. A message sequence can be changed using configuration data without recompiling an application. In embodiments of the present invention, a Control Server can provide services from a single server machine. However, these provided services can be dynamically moved to other server machines. Using SOA the present invention can declare server connections in data rather than code, without recompiling service oriented applications.

### Network Overview

The architecture of the present invention can look and/or function as a P2P network with Control Server model as illustrated in FIG. 1.

An example control server provides discovery, directory and/or user services. The advantage of a central control server is that it allows this technology to know where a user's data is stored. This becomes optionally advantageous as the peer network grows. As an example, a single control server can manage up to 250,000 users. A new control server can be deployed, once the maximum capacity of a single control server is reached. New installations can then use the new control server to create pods of control servers and/or users. This can reduce exposure to losing the entire network and to system redundancy.

Discovery services can act as a mechanism for finding peers in the network. Traditional P2P networks find peers by flooding the network with a single broadcast message. The present invention can employ the control server to find available (currently connected) peers, without flooding the network. For example, when a peer comes online it can register with the control server. While online, the peer can provide a periodic heartbeat to let the control server know it is still active. Before the peer disconnects it can inform the control server that it is no longer online. In this way, a control server can determine which peers are online without having to flood the network with peer search messages.

The directory services can allow peers to quickly find content by maintaining a list of where content is stored on the network. When a peer needs to find something it can query a control server for the location. Then the peer can initiate a transfer with the other peer with approval and direction from the control server. Content can be transferred from P2P and is not from a server. In this exemplary embodiment, Content can be referenced on the server for quick and easy peer discovery. An alternative method can include a broadcast search of the network for the Content. As certain Content may be unique and/or not duplicated many times on the network it can be advantageous to use directory services to locate content.

User services can allow a user to register with a content server system, process payments and/or manage their account. In addition, to the user services of the present invention can host the following websites:
Peer administration websites—manage user accounts, view log files, make payments, view statistics, view storage use, download and/or update software, etc.
System administration websites—administer the entire system, view global statistics (storage, peers, restores, etc.), manage maintenance tasks, manage heuristics

### System Overview

The present invention uses a P2P network with control server architecture. One solution of the present invention can be object oriented and/or service oriented. Service orientation is an architectural style in which distributed application components are loosely coupled through the use of messages and/or contracts. Service oriented applications describe the messages they interact with through contracts. These contracts are to be expressed in a language and/or format easily understood by other applications, thereby reducing the number of dependencies on component implementation.

### Control Server

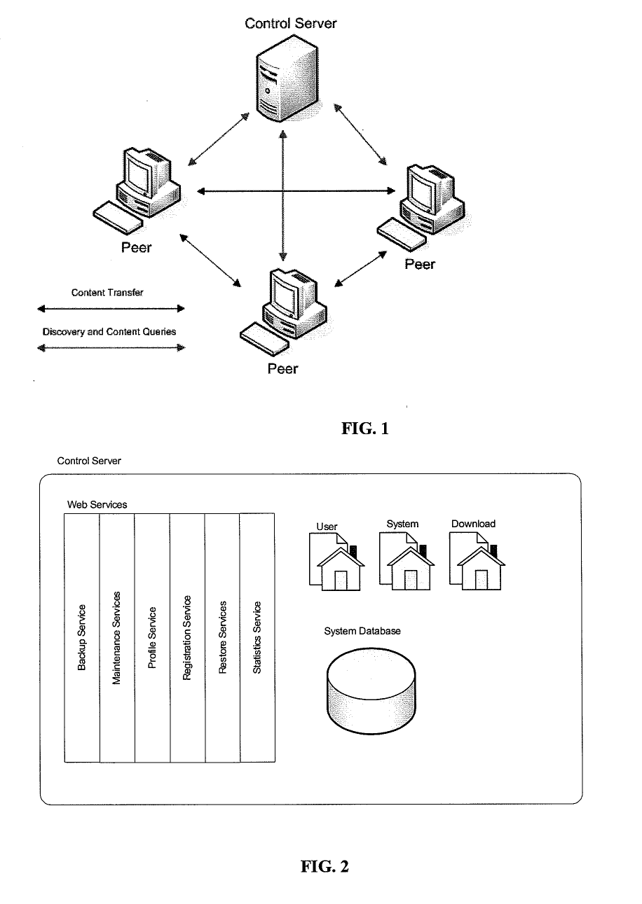

In an embodiment, the control server can host services and/or websites that control the P2P network and/or peer communications. Each service can be self contained and/or not dependent on other services. This can allow movement of services between multiple control servers. In one embodiment, registration services and/or websites can be hosted on one server, while backup, restore, profile, statistics, and/or maintenance services can be hosted on another. In an embodiment, a service can be moved to another server without code changes. The following is a listing of available services that can be associated with a control server in accordance with various embodiments of the present invention (See FIG. 2):
Backup Services: can allow a user to access storage targets and/or upload manifest information.
Maintenance Services: can allow a user to query the server for needed maintenance tasks.
Profile Services: can allow a user to access and/or create profile information for users, machines, disks, and/or drives.
Registration Services: can allow a user to register users, machines, disks and/or drives for first time use.
Restore Services: can allow a user to access information needed to perform a restore operation.
Statistics Services: can allow a user to access and/or create statistics.
User Services: can allow a user to view/update account and/or payment info; view network community features such as basic network statistics, disk space free, and user's rating; and/or configure local machines, etc.
Systems Services: can allow system administrators to view current system health, statistics, reports and/or perform maintenance tasks.
Download Services: can allow users to download the latest software for installation.

### Control Server Structures

### Control Server Tables

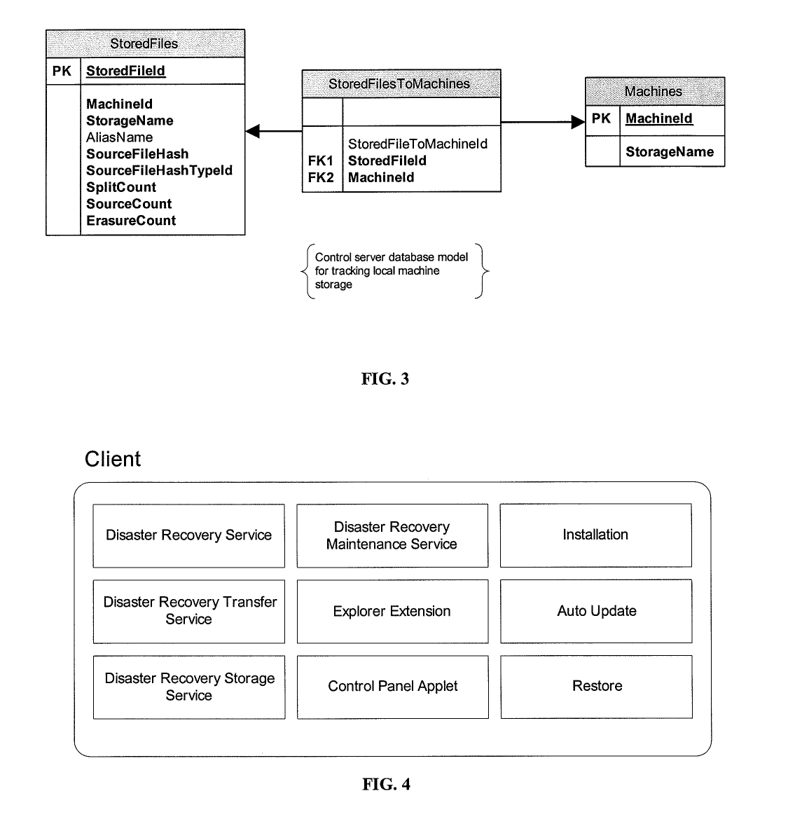

In an embodiment, a Control Server Table structure can track which files are protected and/or where they are stored (See FIG. 3).

### StoredFiles

In an embodiment, a StoredFiles table can track information related to which files are backed up and/or which machine they live on. Fields can include:
StoredFileId—primary key
Machined—foreign key to the machine that owns the file
StorageName—system assigned name of the file
AliasName—when protecting a duplicate file this name is the GUID of the file that is already in the ProtectedFiles table—otherwise its “ ”, empty string
SourceFileHash—hash value of the contents for the original file
SourceFileHashTypeId—hash type—default is SHA-512
SplitCount—the number of chunks the file was split into
SourceCount—the number of original file blocks created during erasure coding
ErasureCount—the number of erasure blocks created during erasure coding

### Client Servers

Client side services associated with various embodiments of the present invention include, but are not limited to, the following services (See FIG. 4):
Disaster Recovery Services: Idle priority Windows service can be responsible for finding, acquiring, compressing, encrypting, splitting, erasure coding, packaging and/or transferring files of interest. This function can depend on the user and/or Storage Service.
Disaster Recovery Storage Services: Idle priority Windows service can be responsible for loading the file system driver and/or implementing an erase ahead algorithm.
Disaster Recover Maintenance Services: Low priority Windows service can be responsible for performing user maintenance and/or statistics tasks.

### Explorer Extension

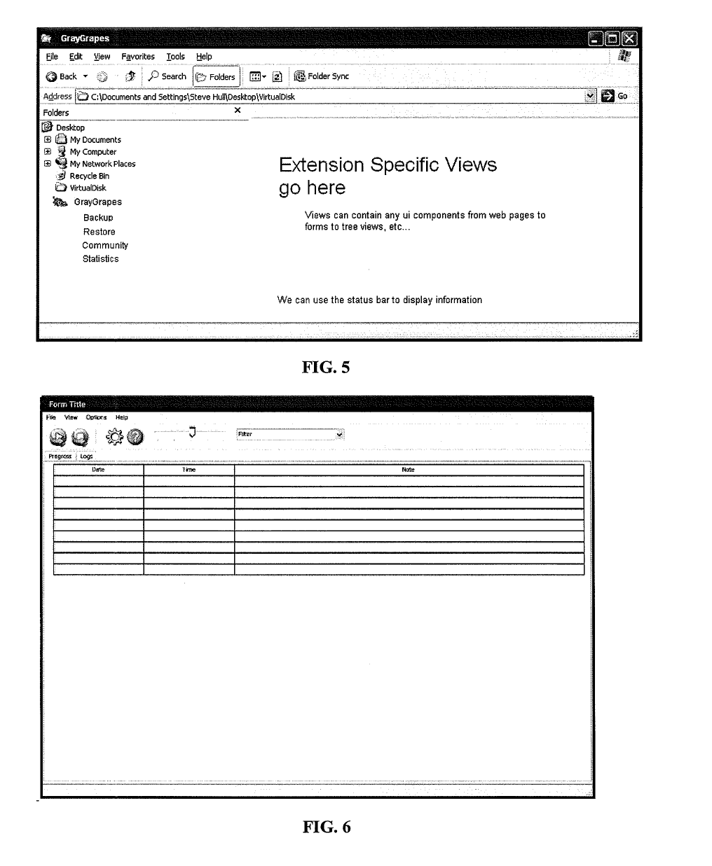

In an embodiment, an Explorer Extension can provides a context menu for include/exclude operations on files and/or directories. The Explorer Extension can also provide restore functionality (See FIG. 5).

### Control Panel Applet

In an embodiment, a Control Panel Applet can allow a user to configure services via an apple interface.

### Installation

In an embodiment, an Installation process can facilitate installation of the software associated with various embodiments of the present invention.

### AutoUpdate

In an embodiment, an AutoUpdate process can automatically update the software associated with various embodiments of the present invention.

### Restore

In an embodiment, a restore process can restore a backed-up data to its original state. An exemplary restore process can rely on an Engine, Thread and/or Task architecture and the following file naming convention.

### Defined Data Structures

Entire List: gets all files from storage target.

Exclude List: gets all files from storage target except those specified.

Include List: gets all files from a storage target specified in the list.

### Restore Process

In an embodiment, the restore process is initiated by the local machine via a restore application. A user can download the restore application when needed. In an embodiment, when the user runs the restore application they can login with a valid user name, password and/or answer at least one security question. The restore process can be initiated via the user account website can then set a value in the user machine's table stating the machine is in “restore mode”.

### Restore Setup

In an embodiment, a Restore Setup process can be performed once to setup initial restore activities. In an embodiment, a Restore application may not finish before the restore setup process is complete so local data is needed to store maintain information. The following is an example of the Restore Setup process:
Call RS.GetRestoreCandidates( ) to get a list of machines for a logged-in user that are in “restore mode”. The machines retrieved and listed may or may/not be the machine the user is currently using. In an exemplary embodiment, only one machine can be listed. A restore user interface can allow the user to select the machine of interest. Persist this value in ConfigFile.
If the backup service is on the local machine it can run while in restore mode.
Call RS.GetStoragePeers(string machine) (10K peers, 350 bytes per record=3.5 MB, about a 20 second download.
Insert info (StorageName, IpAddress, Port) in the StoragePeers table

### Restore Shutdown

In an embodiment, a Restore Shutdown process can include the following:
If local machine and/or machine passed into EndRestore are not the same machines a disposition of the machine is provided. For example, if the machine can no longer be in service it can be retired at the control server and/or all files can be redirected to a new machine. If the user wants to keep both machines in service the control server can copy file pointers to a new machine. If the old machine starts deleting files, the control server can determine not to delete files on a Cloud, before being backed on another computer. In this context, a Cloud can be a group of peers in a P2P network having portions of data pertaining to at least one file data.
When restore is complete call RS.EndRestore(string machine) to remove “machine” from “restore mode”. This prevents any restore applications from corrupting and/or deleting and/or otherwise damaging the data.
Turn on the backup service and download and/or install backup files.

### Online Peers Thread

In an embodiment, an Online Peers Thread updates a StoragePeers table with each peer's online status according to the following process:
Query StoragePeers table for count of peers with IpAddress and/or Port.
If the list contains more than 10 machines remain idle. The number of machines can depends on a Package and/or Download Threads.
If less than 10,
   Call RS.GetOnlineStorageTargets(string machine) to get the list of online peers. The control server restricts the list to the peers related to the specific machine.
   Update StoragePeers records as needed.
Sleep for a predetermined period of time.

### Files Thread

In an embodiment, a Files Thread performs the following process for each peer in StoragePeers table:
Call RS.GetStorecIFiles(string machine) to get a list of all files stored on remote peer. File info can include GUID, Hash, SplitCount, SourceCount, and/or ErasureCode.
Add file info to RestoreFiles and/or RestoreFilesToPeers tables.
   An entry gets created in RestoreFiles when the Storage Name is unique.
   MinForDecode is the SourceCount value.
   MaxDecodeCount is the SourceCount+ErasureCount.
   An entry gets created in RestoreFilesToPeers when the RestoreFileId and/or StoragePeerId pair is unique.
When all files have been processed for a given StoragePeer set the FilesComplete field to the current date/time in the StoragePeers record.
When all records in StoragePeers have FilesComplete!=null this thread can no longer be needed and/or can be terminated.

### Package Thread (Local Machine)

In an embodiment, a Package Thread performs the following process after connecting to an online peer from a local machine:
Execute for a given peer if FilesComplete has a valid date/time.
Ask the peer for package count. This can happen multiple ways:
   Consider all files except files in an exclude list—exclude list can be empty.
   Consider files in an include list.
Create a record for each package (0—n-1) in Packages Table.
Set RequestComplete to the current date and/or time in StoragePeers table, indicating the peer has been contacted and/or is asynchronously making packages.
A remote peer can begin creating packages—each remote peer is given time to create packages before beginning download.
When all StoragePeers records are RequestComplete !=null the thread is finished and/or can be terminated.

### Package Thread (Remote Machine)

In an embodiment, a Package Thread can perform the following process after a Listener Thread is utilized on all peers:
Calculate package count for a requesting peer.
Builds packages—all packages are named <system assigned machine name>.N.Package.N is 0 through count −1.

### Download Thread

In an embodiment, a Download Thread(s) can perform the following process:
Query StoragePeers for any record that has:
   a RequestComplete date/time greater than 5 minutes AND/OR
   if FilesComplete !=null and DownloadComplete=null
Contact remote peer
Begin download of StorageName.N.package
Receive packages to directory
Update date/time in DownloadComplete field in Packages table
Unpack into Restore directory
Notify remote peer download is complete
Remote peer deletes package on its system
Query records in Packages table for a given StoragePeer
   If Packages records are set to DownloadComplete:
      Set DownloadComplete in StoragePeers to current date/time
      Delete related StoragePeers records
Query records in StoragePeers table
   If StoragePeers record is set to FilesComplete, RequestComplete, or DownloadComplete:
      Delete RestoreFilesToPeers records related to StoragePeers record
      Delete StoragePeers record
When DownloadComplete fields in StoragePeers are set to a date/time this thread is no longer needed and/or can be killed.

### Troubleshoot Thread

In an embodiment, a Troubleshoot Thread(s) can calculate what went wrong and how to fix the system when for example, the threads as characterized above have not been terminated, and/or the RestoreFilesToPeers, StoragePeers, and/or Packages tables are not empty.

### Decode QueryThread

In an embodiment, Query RestoreFiles looks for GUID.N.Contents and/or GUID.0.Metadata records where DownloadComplete is null. In an embodiment a Decode Query thread performs the following process:
For Contents files the RestoreFiles record indicates:
   MinForDecode—the minimum number of GUID.N.M.Contents fragments to decode a file. For GUID.0.M.Metadata this is always 3.
   MaxDecodeCount—the total number of fragments M. For GUID.0.M.Metadata this is always 5
   E.g., GUID.3.Contents has MinForDecode=4 and/or MaxDecodeCount=6. Locate GUID.3.M.Contents where M is 0-5 and/or therefore 4 fragments need to be decoded.
   Search Restore directory for GUID.N.*.Contents.
For Metadata files always assume 3 fragments are needed.
When there exists enough fragments for decoding set DownloadComplete to current date/time in the RestoreFiles record.
If more than MinForDecode (or 3 for Metadata) fragments are found create a Decode Task; Otherwise move onto the next record.

### Decode Task

In an embodiment, a Decode Task performs the following process:
Decode GUID.N.M.Contents into GUID.N.Contents. N is any valid split sequence number. M is the set of numbers required to decode into GUID.N.Contents.
Delete GUID.N.M.Contents files—there should be 1 GUID.N.Contents file in the restore directory.
Delete Task—No task promotionrequired.
Decode GUID.0.M.Metadata into GUID.0.Metadata.
Delete GUID.0.M.Metadata files; there should be 1 GUID.0.Metadata file in the restore directory.
Promote to Decrypt Task—working file is GUID.0.Metadata
Set RestoreFiles DecodeComplete field to the current date/time.

### Stitch Thread

In an embodiment, Query RestoreFiles looks for GUID.N.Contents records where DownloadComplete AND/OR DecodeComplete are not null. A StitchThread locates a set of GUID.*.Contents files where records can be Download and/or Decode complete. In an embodiment, StitchThread performs the following process:
If enough files exist create GUID.0.Contents
Delete RestoreFiles except GUID.0.Contents—note: there should not be any foreign keys in RestoreFilesToPeers table.
Set RestoreFiles StitchComplete to the current date/time.
Create DecryptTask thread.

### Decrypt Task

In an embodiment, a Decrypt Task performs the following process:
Decrypt the working file
Set RestoreFiles DecryptComplete to the current date/time
Promote to Decompress Task

### Decompress Task

In an embodiment, a Decompress Task performs the following process:
Decompress the working file
Set RestoreFiles DecompressComplete to the current date/time
Promote to Reconstruct Task

### Reconstruct Thread

In an embodiment, a Reconstruct Thread performs the following process:
Locate GUID.0.Contents and/or GUID.0.Metadata
Reconstruct file in original location with file info and/or acts
Delete the Task
Delete GUID.0.Contents and/or GUID.0.Metadata
Set RestoreFiles RestoreComplete field to current date/time

### User Interface

In various embodiments, a Logs view and a Progress view user interface can appear as illustrated in FIGS. 6 and 7.

### Client Data Structures

In an embodiment, database backup structures can be stored in a central backup.vdb file stored in a directory. The database can live on peers running the software. A database can also be kept on a central server as well as in GUID.0.Metadata files.

### Local Database Tables

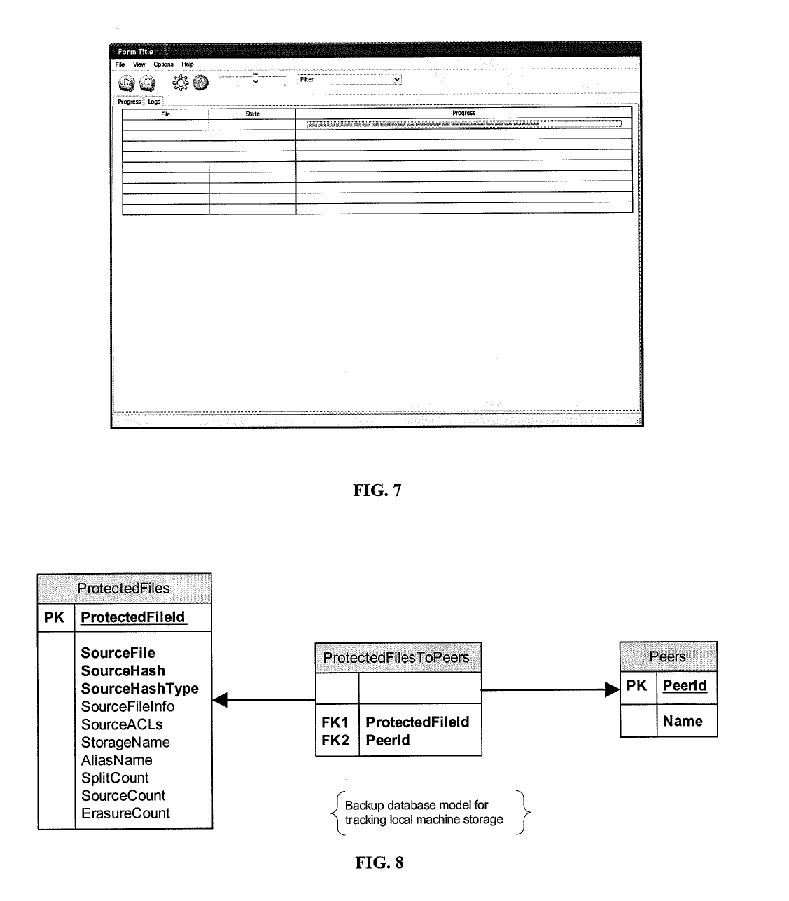

An exemplary ProtectedFiles table structure is shown in FIG. 8 that can track protected files on a local machine. These files are owned by the local machine and/or users (e.g., user's files, See FIG. 8).

### ProtectedFiles Table

In an embodiment, the ProtectedFiles table can track information related to the files that are backed up on the local machine. Fields can include:
ProtectedFileId—Primary key
SourceFile—fully qualified path to the file being backed up
SourceHash—hash value of SourceFile's contents
SourceHashType—type of hash used—default is SHA-512
SourceFileInfo—persistent FileInfo structure
Source Acls persistent access control list
StorageName—system assigned name. This is the root component of GUID.N.M.Contents and/or GUID.0.Metadata
AliasName—when protecting a duplicate file this name is the GUID of the file that is in already in the ProtectedFiles table—otherwise this value is “ ”, empty string
SplitCount—the number of chunks the file is split into to make it manageable
SourceCount—the number of original file blocks created during erasure coding
ErasureCount—the number of erasure blocks created during erasure coding

### Peers

In an embodiment, a Peers table can track a peer name associated with the peer used by the local machine for storage. Fields can include:
PeerId—primary key
Name—system assigned unique name for the peer

### ProtectedFilesToPeers

In an embodiment, a ProtectedFilesToPeers table creates a many-to-many relationship between ProtectedFiles and/or StoragePeers. Fields can include:
ProtectedFileId—foreign key to ProtectedFiles Table
PeerId—foreign key to StoragePeers Table

### Remote Database Tables

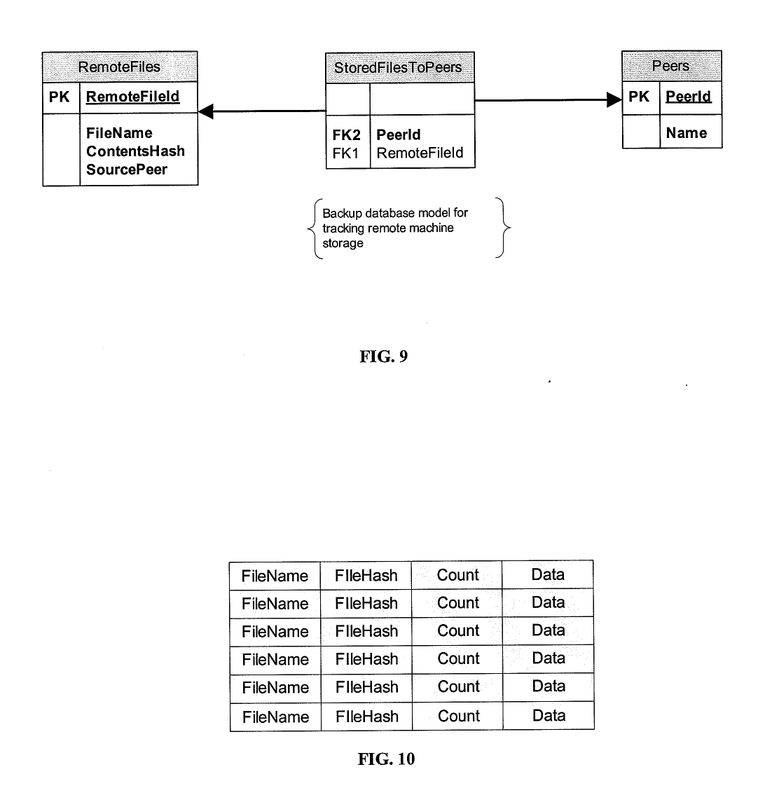

In an embodiment, a RemoteDatabase table structure can track files that can be stored on a remote computer The files can be temporarily on the remote machine and/or can be moved or erased at any time. The path and/or contents of the files can be unrecognizable. Each file can be a fragment of an original file (See FIG. 9).

### StoredFiles

In an embodiment, a StoredFiles table structure can track files stored on the local machine. Fields can include:
StoredFileId—primary key
FileName—system assigned name. This can be the root component of GUID.N.M.Contents and/or GUID.0.Metadata
SourcePeer—system assigned name of who owns the file.

### StoredFilestoPeers

In an embodiment, a StoredFilestoPeers table structure can track files stored to peer's local machine. Fields can include:
SourcePeerId—foreign key to SourcePeers
StoredFileId—foreign key to SourceFiles

### File Types

### Contents

In an embodiment, a Contents file contains content of the original file and/or takes the form GUID.N.M.Contents, where:
GUID is a unique identifier—this is the root for files related to an original file.
N is the split sequence number. If a file is split into 10 chunks, 10 files can be created GUID.0-9.Contents.
M is the erasure code sequence number. If a file is erasure coded with a 3:2 ratio 5 chunks can be created GUID.N.0-4.Contents. Chunks 0-2 contain original file info, whereas chunks 3 and/or 4 are erasures. Any 3 chunks can reconstruct the original file.
Contents can be the file extension that indicates that this file contains content information and/or to be paired with a Metadata file.

### Metadata

In an embodiment, a Metadata file contains Version, Contents Hash, Hash Type, Compression Type, Encryption Type, Source File Info, Access Control List, Split Count, Source Count, Erasure Count, Erasure Count Padding, and/or Split Padding. In short, the Metadata file contains the bookkeeping related to the Contents file. It takes the form GUID.N.M.Metadata, where:
GUID can be a unique identifier related to GUID.N.M.Contents
0 is the single instance of a split sequence number. In certain embodiments Metadata is not split mainly because it can be rather small therefore splitting may not required. Using 0 maintains a uniform naming convention with Contents files.
M is the erasure code sequence number—Metadata can have 3:2 ratio, therefore, this value can be 0-4.
Metadata can be the file extension that indicates that this file contains metadata info and/or to be paired with a Contents file.

### Package

In an embodiment, a Package can be a container used to make transfers more efficient by avoiding many small file transfers. A package can be sent to a single destination. Once files are protected the packages can get smaller and/or can contain related files. A peer maintenance task can check local machines for overlap and/or take action. Along with each Package the present invention can have a sister file with the same GUID and/or a .Manifest extension.

FIG. 10 illustrates an example Package structure in accordance with an embodiment of the present invention.

The Package structure can consist of repeating variable length records that include:
File Name—the system assigned name of the file in this package, e.g., GUID.N.M.Contents and/or GUID.0.M.Metadata
File Hash—a hash of the GUID.*file. This can be used to verify data on the other side of the transfer
Length—the number of bytes contained in Data
Data—the actual data from GUID.*

Package1

In an exemplary embodiment, a Package1 is a container used to make transfers more efficient by avoiding many small file transfers. Package1 can be used for large files. The format is the same and/or substantially similar to the Package described above, however this embodiment of the present technology uses the Package1 extension to keep small and/or Large File Threads from tripping over each other. When a Package1 file is ready for transport it is changed to Package.

### Package2

In an exemplary embodiment, a Package2 is a container used for small files. The format is the same and/or substantially similar to the Package described above, however this embodiment of the present technology uses the Package2 extension to keep small and/or Large File Threads from tripping over each other. When a Package2 file is ready for transport it can be changed to Package.

### Manifest

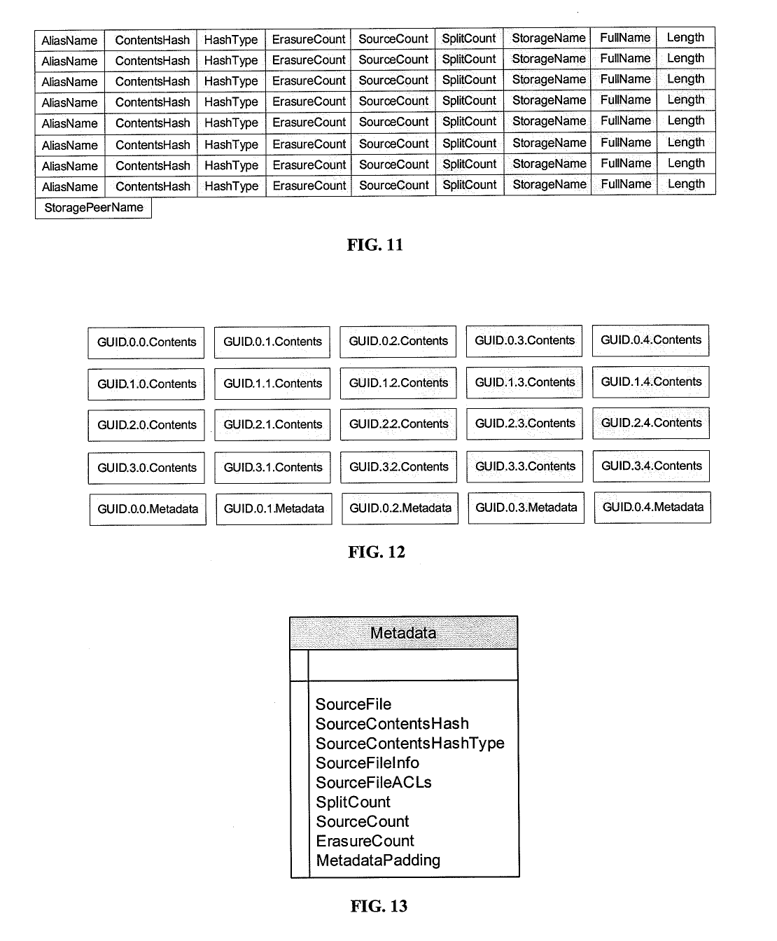

In an embodiment, a Manifest can contain bookkeeping information about individual files within the related package. After the Package is successfully sent to a storage peer the Manifest is uploaded to the control server. An example Manifest is illustrated in FIG. 11. The Manifest structure can consist of records including:
AliasName—when a duplicate file is found (contents the same, file name different) this can be the name of the 1^{st} file backed up. During restore one embodiment of the present invention can use the alias to locate the file contents and/or then merge the current metadata info to reconstitute the original file.
ContentsHash—hash value of the original contents file
HashType—type of hash algorithm used
ErasureCount—count of blocks created when erasure coding
SourceCount—count of original file blocks created when erasure coding
SplitCount—count of the number of file chunks created to make a large file manageable. SplitCount can be used for files over 10 MB.
StorageName—system assigned guid
FullName—full qualified path of the original tile
Length—original file size

### Using

In an embodiment, Using is a transitional extension used to identify files in transition from one state to another. For instance, when a file is being compressed it can be renamed to Using. Likewise when decompressing and/or for other file level operations.

### RestoreRequest

In an embodiment, a RestoreRequest, contains information about a source machine that a storage machine can use to return packages of files during the restore process.

### Backup Process

In an embodiment of the invention a Backup process, is a scanner that can run on a Small File and Large File Threads traversing a disks directory structure looking for files that need to be protected. In one embodiment, the Backup Process is completed via a scanning model for FAT32. In another embodiment a scanning model for NTFS can be included to take advantage of the NTFS Change Journal (a.k.a. USN Journal).

### Large and Small File Threads

In an embodiment, at least two file thread types can be used to process the files. For example one file thread can be for large files >5 Mb and one file thread can be for small files <=5 Mb. Large files can take much longer to process, which can cause the process to slow. Also, large files require some special handling at times.

### Small File Thread

In an embodiment, the erasure code padding, compressed, encrypted, and split file size cannot be calculated, therefore the contents of the file are processed to packaging first. Then, the metadata file is updated and processed the same way except hard coded values for the hash type, encryption type, erasure code counts, and compression counts are used. A protected file record can be added after the contents and metadata are packaged.

### Large File Thread

In an embodiment, the Large File Thread can work in a substantially similar way as the Small File Thread except the protected file record can be added after the file is acquired and updated at different stages along the way. In this embodiment, if the thread is interrupted, recovery is possible mid-process and resources are not wasted in starting over. An example task overview can include a working directory for files being processed. The working file object can be used here to store and transport data about the file and process. It can contain a storage file object which holds processing info, status and file metadata. It can also contain a protected file record that interacts with the user database.

### Acquire Contents

In an embodiment, an exemplary Acquire Contents process can get the real disk-free space for a given drive. If the free space is less than the required buffer, the process will do nothing with this task and either determine if another drive has more free space and use that drive for temporary files, or put the thread to sleep for a predetermined number of minutes. This effectively gives a Transfer thread time to send files making space on the drive.

In an embodiment, if adequate space is available, the file can be acquired in accordance with the following example process:
Generate a GUID to represent the file
Copy the original file to GUID.0.0.Contents
Remove any non-normal attributes from GUID.0.0.Contents.
Hash the contents of GUID.0.0.Contents and store in the MetaData object.
Update protected file record object and if this is the Large File Thread, update Protected Files table in backup database.

in this example process, the file name can be changed but the contents are maintained the same; the data copied and collected.

### Compress Contents

An example Compress Contents process can include the following steps:
Compress GUID.0.0.Contents using the bzip algorithm. The algorithm can be modified if needed.
Update protected file record object and if this is the Large File Thread, update Protected Files table in backup database.

### Encrypt Contents

An example Encrypt Contents process can include the following steps:
Contact control server and get the system assigned key and vector for the machine.
   Encrypt GUID.0.0.Contents files using AES encryption. This type can be modified if needed.
   Update protected file record object and if this is the Large File Thread, update Protected Files table in backup database.

### Split File

An example Split File process can include the following steps:
Calculate the file to be split. (Note: The fact that compression changes the length of the file is a given, however encryption can also change the file length by a small number; therefore, the calculation can be made after encryption is completed. Split files are >10 Mb. SplitCount=(File Length/Max Piece Size) rounded up to the nearest integer). The Split Padding is then calculated, which is the remainder of the FileLength divided by SplitCount.
Update the SplitCount (N) and Split Padding in the MetaData object.
Split GUID.0.0.Contents to create GUID.0—(N-1).0. Contents chunks—Note: the final chunk is to be padded and unpadded when stitched.
Update Protected File Record object and if this is the Large File Thread, update Protected Files table in backup database.

The single original file can be represented on disk as N split files.

### Erasure Code File

An example Erasure Code File process can include the following steps:
Calculate the ErasureCount(X), SourceCount(Y), and ErasureCodePadding. ErasureCount and SourceCount dynamically generated from the Control Server.
Erasure Code GUID.N.0.Contents creating GUID.N.(X+Y).Contents.
Update Protected File Record object and if this is the Large File Thread, update Protected Files table in backup database.

After GUID.N-1.0.Contents files are erasure coded the original file can be located on disk as N*(X+Y) file fragments (See FIG. 12).

### Process Metadata

An example Process Metadata process creates a GUID.0.0.Metadata file and store (See FIG. 13):
Version—the version number for specified metadata.
Contents Hash—a hash of the file so it does not become corrupted.
Hash Type—enum value currently set to SHA512.
Compression Type—enum value currently set to BZIP.
Encryption Type—an enum value currently set to AES.
Source File Info—attributes, directory info, modified and create times, etc.
Access Control—List set of access rules for the file.
Split Count—number of file chunks created when splitting the file.
Source Count—number file chunks created during erasure coding.
Erasure Count—number of erasure chunks created during erasure coding.
Erasure Code Padding—number of bytes to be added to the file so that an erasure code can be properly completed.
Split Padding—number of bytes to be added to split the file into equal chunks.

Compress

See Compress Contents above.

Encrypt

See Encrypt Contents above.

Erasure Code

Use fixed Erasure Code ratio of 4:4

### Package File

An example Package File process can include acquisition of a list of available Packages not awaiting transfer and looping though the list of packages placing one chunk in each package. If the list of Packages is less than the number of total chunks (split and erasure code), a new Package can be created for each thereafter. When a chunk is added to the Package, data regarding the chunk is added to the Manifest. The following is added to the end of the Package:
File fragment name—GUID.N.M.Contents or Metadata
Hash of the file fragment—default hash is SHA-512
Length of the file fragment in bytes

Then the Manifest is updated, and if the Package is over 1 Mb it is moved with the Manifest to the Outgoing directory.

### Package File Extensions

In an embodiment, when a Package is in process and not sitting in the outgoing directory awaiting transfer it can have one of two file extensions, .Package1 and .Package2 depending on if it is being processed by the Small File or Large File Thread respectively. This is done so that the threads do not collide. When the Package is moved to an Outgoing Folder, the “1” and “2” signifiers are truncated.

### Handling Old Packages

In an embodiment, when Packages are “old”, for example a set time period which can be over one hour old, they can be moved to the Outgoing Directory regardless of size. Cloud Maintenance Algorithms can handle balancing the machine so that the storage peer is not overloaded for this source.

### Package Transfer

An example Package Transfer process can include the following steps:
Send the Package to a peer and report to the control server.
Contact control server and receive a list of online peers. In an embodiment, this can be cached on the local machine.
Connect to peer and negotiate transfer.
Generate hash value for Package. This provides an opportunity to insure that the Package is intact on the storage machine. In an embodiment, a TCP transport can be used so the Package can remain intact.
Send hash value and Package to remote peer.
If transfer is successful, append the TransferPeer GUID to the Manifest file and change the Manifest file extension to CompleteManifest. Then, upload a BackupManifest using the Manifest file to the Control Server, delete Package and related CompleteManifest.
If the Manifest upload fails it is left and the Transfer thread can try again later.

Although in certain embodiments it can be advantageous to distribute to the widest audience of storage peers as possible, in alternative embodiments it be beneficial to keep the target list smaller. For example, it can be more practical to have a single file fragment on a storage machine rather than a hundred fragments. In accordance with an embodiment of the invention a threshold limit can be set where this is impractical.

The remote peer receives the transferred file as follows:
When receiving the file the remote peer decides which drive to put the Package on. There can be many factors in making this decision, including space available on an internal or external drive.
Save Package contents to directed drive.
Return success indicator to source peer.

### Backup Unpack Thread

In an embodiment, the remote peer can unpack the packages and update its records as follows:
Open package
Copy individual contents directed drive
Update the Remote File Record in the client database

### Scanning

In an embodiment, GUID.N.M.Contents and GUID.0.M.Metadata are created and distributed to the Cloud. Detect file is of interest using available Include, Exclude, and Always Exclude tables, created at the time of the Install. Include table contains directories that can recurse into files. Always Exclude can contain directories to calculate at install which files should not be included in a scan, e.g., temp directories, and system directories. The Exclude table can contain directories that the user can chose to not back up. The Scanner invoked via the Small File Thread looks at files <5 Mb and the Scanner invoked via the Large File Thread looks at files >=5 Mb. The Scanner invokes events that the Small and/or Large File Threads then handle accordingly.

### Protect New File

In an embodiment, a Protect New File process can include, but is not limited to, the following steps:
Detect if file is of interest.
Verify the file is NOT already protected by checking the ProtectedFiles table SourceName column.
Verify the file is NOT a duplicate by hashing the file and querying the ProtectedFiles table for the same hash.
Trigger a FoundNewFile event that is then handled in the Small and Large File Threads.

### Protecting Duplicate File

In an embodiment, GUID.0.M.Metadata is created and distributed to the Cloud and creates a Protected File Record referencing the original file via an alias. An example Protecting Duplicate File process can include the following steps:
Detect if a file is of interest.
Verify the file is NOT already protected by checking the ProtectedFiles table SourceName column.
Calculate hash value of the file and query the ProtectedFiles table for the same hash,
Verify the record found in the above step still exists in its original location to determine if the file is duplicated or moved.
Assign a GUID for this file.
Create an entry in ProtectedFiles for the duplicate file.
Copy the info from the existing hash matched record to the new record.
In the new record assign AliasName to the existing StorageName.
Trigger a ProtectMetadata event.

### Protecting Content Changes

In an embodiment, GUID.N.M.Contents and GUTD.0.M.Metadata are distributed to the Cloud. Previous GUID.N.M.Contents and GUID.0.M.Metadata can be orphaned in the Cloud. In another embodiment a NTFS change journal can be used to reduce overhead. An example Protecting Content Changes process can include the following steps:
Detect if file is of interest
Verify the file is already protected
Verify the hash values of the file and the ProtectedFiles record do not match
Notify Control Server to Orphan the GUID.N.M.Contents and GUID.0.M.Metadata fragments of the file found in ProtectedFiles record.
Delete ProtectedFiles record.
Trigger a FoundNewFile event.

### Protecting File Moved or Name Changed

In an embodiment, GUID.0.Metadata is created and distributed to the Cloud. In another embodiment, previous GUID.0.M.Metadata can be orphaned in the Cloud. An example Protecting File Moved or Name Changed process can include, but is not limited to, the following steps:
Detect file is of interest
Calculate the hash value
Collect records from the ProtectedFiles table that have the same hash value
Verify SourceFile path in each ProtectedFiles record does not exist
Notify Control Server to Orphan the existing GUID.0.Metadata fragments
Update the matching ProtectedFiles record to the new SourceFile and the FileInfoAndAcls hash.
   Trigger a ProtectMetadata event.

### Protecting Metadata Changes

In an embodiment, GUID.0.Metadata is created and distributed to the Cloud. In another embodiment, previous GUID.0.M.Metadata is orphaned in the Cloud. An example protecting metadata changes process can include, but is not limited to, the following steps:
Verify the file is not new, duplicated, or moved/name changed
Notify Control Server to Orphan the existing GUID.0.M.Metadata fragments
Update the matching ProtectedFiles record to the new SourceFile and the FileInfoAndAcls hash.
Trigger a ProtectMetadata event.

### Client Database Funtional Specification

Editing and/or Deployment

In an embodiment, a backup database can consist of BackupDefinition.VDB and/or vdc3 files. This can be an empty database used for definition purposes. Additionally a BackupDefinition.xml can be used to create a real working database.

Modifications to the database can be made in the BackupDefinition.VDB using the Data Builder utility by the following exemplary steps:
Checkout BackupDefinition.*files from source safe
Make modifications
Select File->)XML, Import and/or Export
Move Available Tables to the list box (on the right)
X Select the “Export Data And/or Schema” button
Select the BackupDefinition.XML file as the output
Check BackupDefinition.*files into source safe
Rebuild InstallSim to update the working database schema

### Schema

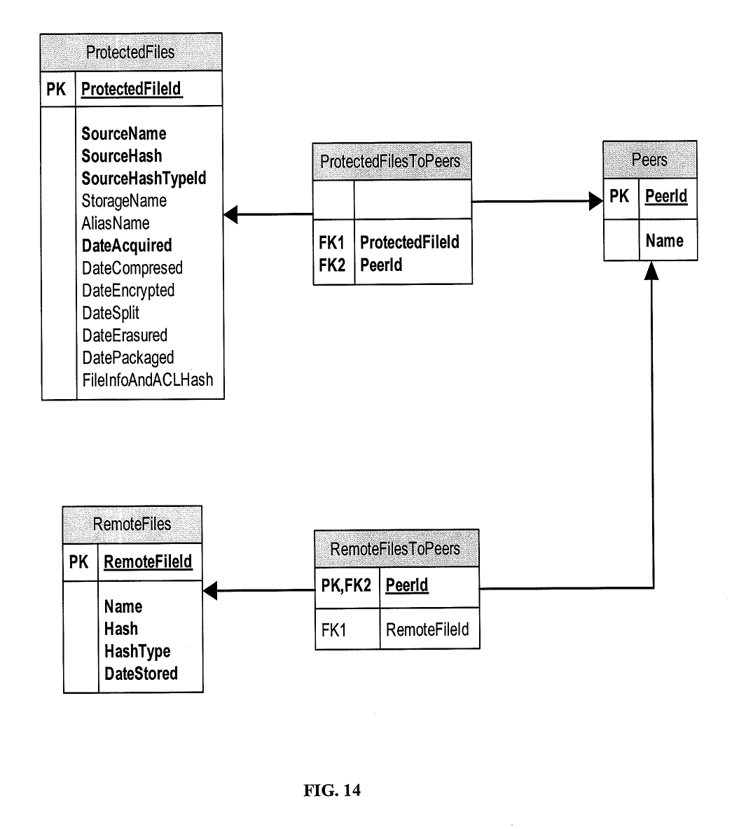

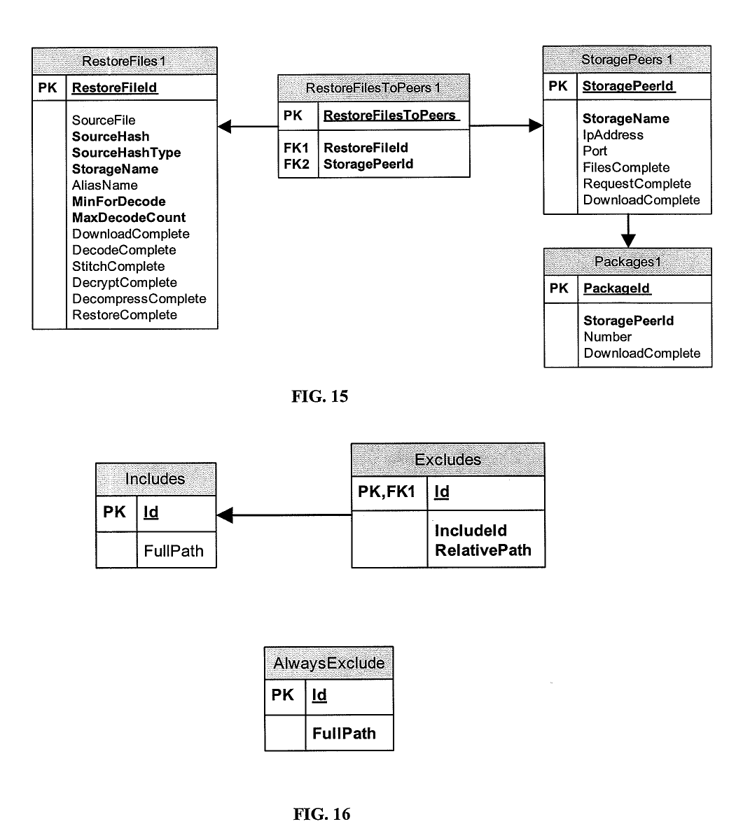

FIGS. 14-16 illustrate various schema in accordance with embodiments of the present invention.

### Maintenance Processes

### File Decay

In an embodiment, a File Decay process occurs when a file's chunk count degrades to a level putting a successful restoration in jeopardy. Several things can happen that reduce the chunks stored on the Cloud. In some situations, reduction can be anticipated by the user, e.g., the chunks stored on the Cloud may be reduced in the Erase Ahead process. In other instances there is no prior knowledge, for instance, when a machine dies. In either case the software can be enabled to do the following:
Identify chunks of files are missing
Determine if the missing chunks put the backup at risk of failure
Restore the chunks

### File Copy

In an embodiment, when a machine is restored from M1 to M2 it can create a situation where the same file is present on multiple machines. Depending on how this matter is handled, this situation can dictate whether a copy job is needed. If a copy job is needed, then it can occur by the following exemplary steps:
Identify files currently duplicated on M2 from M1
Find peers that have M1 files
For each file generate a new name and/or copy to the M2 storage directory
Update CS M2 file info

### Orphans

In various embodiments, Orphans occur when chunks on the Cloud are not associated with an original file on a source computer. There are many ways an Orphan can be created, such as when files are caught in working folders and outgoing/incoming folders, when a machine is uninstalled, when a file is changed, and/or when a file is deleted. Irrespective of how Orphans are created they can be handled by a substantially similar process, for example, the following steps can be employed:
File delete—When a file is deleted on the local machine the storage files are still on the Cloud. After a period of time, for example, 30 days, the storage files can be deleted to give the user an opportunity to get the files back if they need them.
File change—When a file is changed an Orphan File is created for the current storage files and/or new files are created. The Orphan Files are targeted for deletion.
Machine uninstall—When a machine is uninstalled Orphans can be created. After a period of time, for example, 30 days the storage files can be deleted.

No matter how a file is orphaned the software is enabled to do the following:
Identify chunks of a file that have been orphaned.
Delete the chunk.

### Cloud Balance

### Underweight

In various embodiments, storage is under weighted on too many machines, very few files are stored on a lot of machines.

### Overweight

In other embodiments, storage is over weighted on too few machines, lots of files are stored on a few machines.

### System Architecture

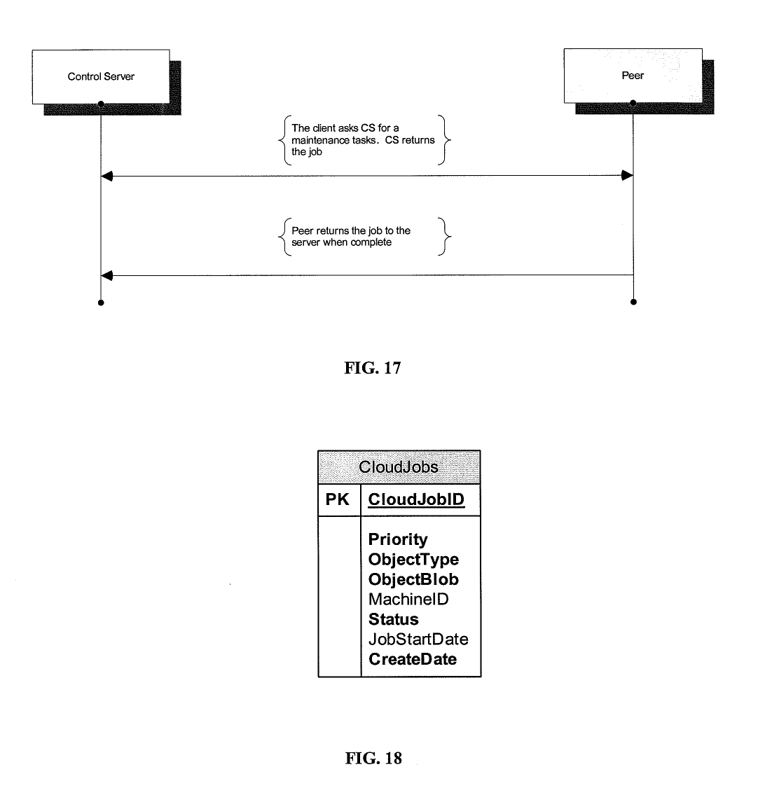

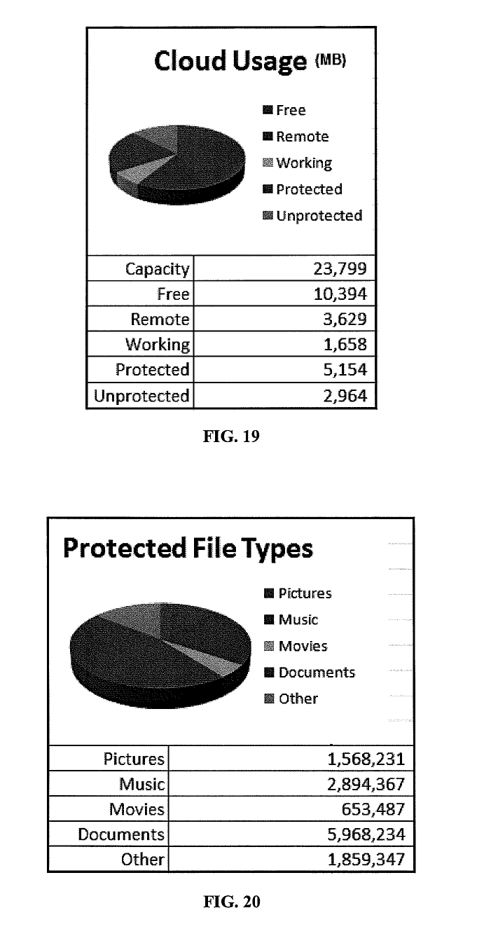

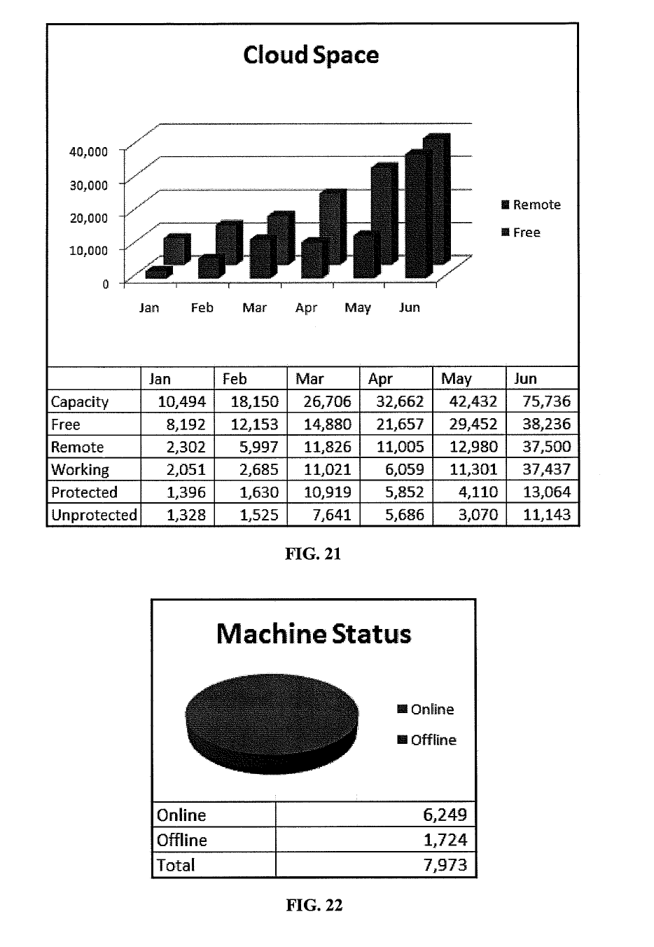

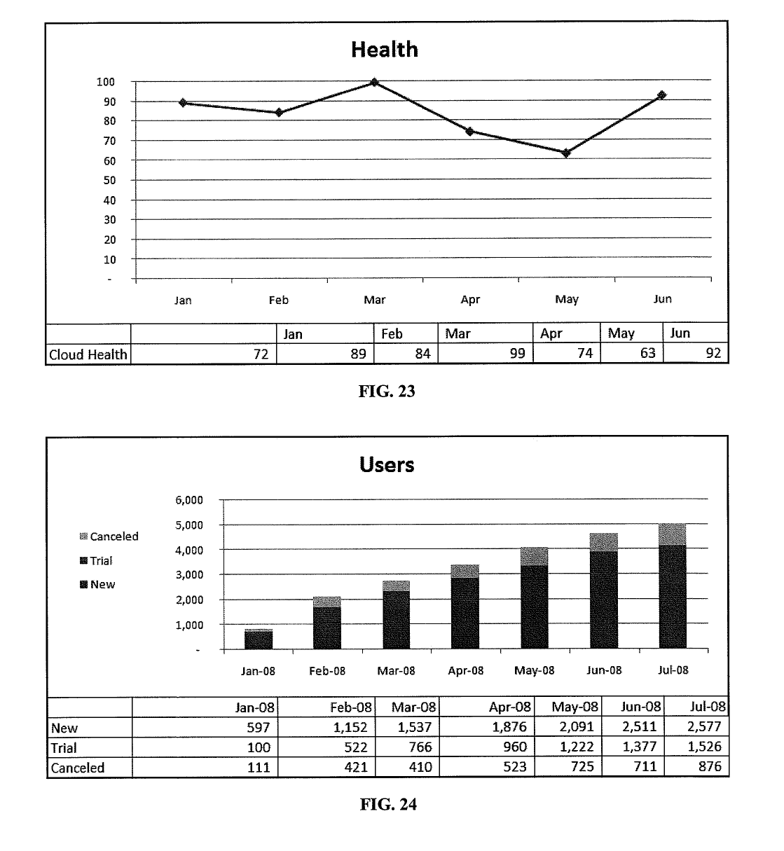

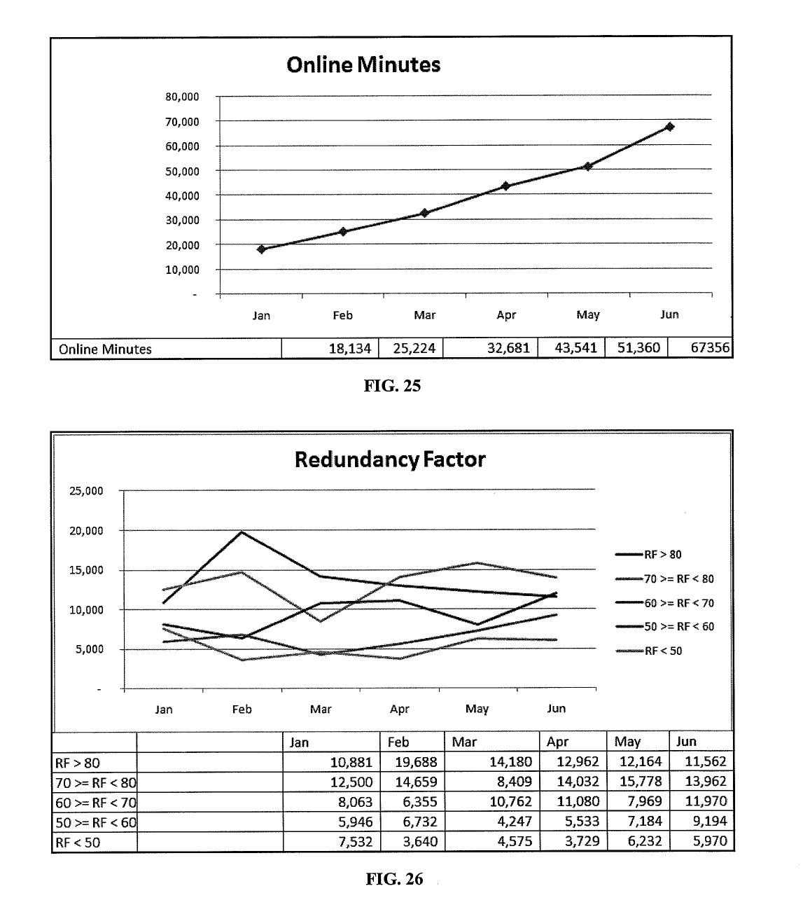

In other embodiment, the overall system process can be carried out as depicted in FIG. 17.

### Server Process

In an embodiment, a server process can include, but is not limited to, the following:
Create Job Records—async processes via scheduled executables
Respond to Maintenance.GetJob( )
Return the highest priority job(s)
Update record
Respond to Maintanance.SetJob( )
Update record
Create object and/or call ProcessReturn—probably async

### Client Process

In an embodiment, a client process can include, but is not limited to, the following:
Call Maintenance.GetJob( )
Save JobSpec to disk
Open JobSpec and/or deserialize into BaseCloudJob object
Call DoClientWork( )
Call Maintenance.SetJob( )

### Maintenance Service

CloudJobSpec[ ] GetJob( )

In an embodiment a user calls a CloudJobSpec[ ] GetJob( )method to get new jobs. The method returns 1 or more CloudJobSpecs. The server queries the CloudJobs table looking for jobs for this peer. If none found it creates and returns a NothingToDo job.

SetJob(BaseJobObject)

In an embodiment a user calls a SetJob(BaseJobObject) method when the job is complete, returning the modified BaseJobObject. User cleans up any residual information. The server receives the JobObject

### Objects

JobSpec

A container for passing a BaseCloudJob object to the User

Properties

String ObjectType—fully qualified job object type. E.g. GrayGrapes.Maintenance.NothingToDo

UInt JobPriority—the priority of this job

Byte[ ] SerializedObject—array of bytes containing the serialized version of ObjectType

Methods

BaseCloudJob GetCloudJobObject( )—creates an instance of the CloudJob object
SetCloudJobObject(BaseCloudJob)—saves the current CloudJob object within the JobSpec
Save( )—saves the JobSpec to disk
Load( )—loads the Job Spec from disk

### CloudJob

Contains all the data and/or methods to perform a job on a specific client.

ICloudJob

Interface definition of a CloudJob containing the following methods:

DoServerWork( )—Server side execution—performs the server work to determine if a job is and/or create the job and/or CloudJobs record.

DoClientWork( )—Client side execution—performs the client work to process a job. The client is free to do just about anything within this method

ProcessReturn( )—Server side execution—performs and/or post client processing. This may include creating more jobs

Serialize( )—serializes the object Deserialize( )—deserializes the object

BaseCloudJob

Implement ICloudJob and/or provides default handlers for the methods described above.

Derived Jobs

Provide Jobs specific functionality for the methods above.

NothingToDo

When there is nothing for a peer to do CS returns this object.

DoServerWork( )—returns all done

DoClientWor( )—returns all done

ProcessReturn( )—returns all done

VerifySource

DoServerWork( )—generates a list (ServerList) of files (with associated chunk count and/or storage machineids) filtered by the source MachinelD.

DoClientWork( )—verifies ServerList with ProtectedFiles record information. If the User can process the difference immediately it should otherwise put the difference in list (DiffList) to return to the server.

ProcessReturn( )—process the DiffList

VerifyStorage

DoServerWork( )—generate a list (ServerList) of files filtered by storage MachineID and/or source MachineID.

DoClientWork( )—verifies ServerList with RemoteFile record information. If the User can process the difference immediately it should otherwise put the difference in list (DiffList) to return to the server. The object should allow processing for one or more source peers to be verified. The limitation can be the amount of data from the server.

RepairFiles

DoServerWork( )—generates a list (ServerList) of files filtered by source MachineID that is to be backed up again because the user's chunks count is getting critically low.

DoClientWork( )—find the ProtectedFile record associated with each file in ServerList and/or remove the record. The next scan cycle can back up the file. Move ServerList to the OrphanList as the present invention processes each item so the server can orphan the files during ProcessReturn( ).

ProcessReturn( )—orphans the files contained in the OrphanList

### CloudJobs Table

In an embodiment this table contains all the information to initiate and/or terminate a peer job (See FIG. 18).
CloudJobID—primary key
Priority—a value of 1-5. 1 is highest, 5 is lowest. Initially all jobs can be 3
ObjectType—qualified job object type. E.g. GrayGrapes.Maintenance.NothingToDo
ObjectBlob—of bytes containing the serialized version of ObjectType
MachineID—the peer that can receive this job
Status—New, ServerProcessing, ReadyForClient, ClientProcessing, ProcessReturn
JobStartDate—set to current date when job is returned to the user for processing
CreateDate—date this record is created

### Directory Structure

In an embodiment, a drive used for backup, restore and/or storage purposes can contain the following directory structure:

```
<drive>:\Storage - root directory for storage space
  \Backup - directory for backup activities
    \Local - directory for all activities related to original files on the local
  machine
      \Processing - contains files being processed. A user can find
    copies of original files, contents, metadata, using, manifest,
    package1, and/or package2 files in this directory. This is a
    transitional directory and/or should eventually be empty.
      \Outgoing - contains packages ready to be sent to storage
    machines. This is a transitional directory and/or should eventually be
    empty.
    \Remote - directory used to store files from a source machine
      \Incoming - contains packages being received for storage. This is a
    transitional directory and/or should eventually be empty.
      \Storage - contains directories for each machine this machine is
    storing files for. This directory can contain many files.
        \<Machine GUID> - contains contents and/or metadata files
      for a given (Machine GUID) machine. Note: a sub directory is
      created for every unique machine guid.
  \Restore - directory for restore activities
      \Local - directory for activities related to original files on the local
  machine
        \Incoming - stores incoming packages. This is a transitional
      directory and/or should eventually be empty.
        \Processing - contains files being processed. A user can find
      copies of contents, metadata, and/or package files in this directory.
      This is a transitional directory and/or should eventually be empty.
        \Storage - stores fully reconstituted files before being moved to
      their original positions on the disk.
      \Remote - directory for activities related to processing storage files
  that get returned to the a source machine.
        \Outgoing - stores outgoing packages. This is a transitional
      directory and/or should eventually be empty.
      \Storage - contains RestoreRequest files. This is a transitional
  directory and/or should eventually be empty.
```

### StoragePeers

In an embodiment, a StoragePeers table can track the unique peer name of the peer used by the local machine for storage. Fields can include, but are not limited to:
StoragePeerId—primary key
Name—system assigned unique name for the peer

### RemoteFiles

In an embodiment, a RemoteFiles table structure can track files stored on the local machine. Fields can include, but are not limited to:
RemoteFileId—primary key
Name—system assigned name of the file fragment
Hash—the hash value of the file fragment
HashType—the hash algorithm used
DataeStored—date the fragment was stored

### SourcePeers

In an embodiment, a SourcePeers table can track the unique peer name of the peer that owns the files stored by the local machine. Fields can include, but are not limited to:
SourcePeerId primary key
Name—system assigned machine name

### RestoreFiles

In an embodiment, a RestoreFiles table can track information related to every file that is being restored on LM. StorageName can be unique and/or take the form GUID.N.Contents or GUID.0.Metadata. Our scanning processes can make intelligent decisions about when enough file fragments have been downloaded. All bold fields are. Fields can include, but are not limited to:
RestoreFileId—Primary Key
SourceFile—fully qualified path to the original file. This value might not be known until the file is restored because this information is contained in GUID.0.Metadata
SourceHash—hash value of source file—when entries are put into this table the original source file is not known. A download of *.Metadata determines original file location, file info, and/or ACLs
SourceHashType—type of hash used—default is SHA-512
StorageName—Always GUID.N.Contents or GUID.0.Metadata. Due to erasure coding we can download many GUID.N.M.Contents and/or GUID.0.M.Metadata files. These files can be decoded into GUID.N.Contents and/or GUID.0.Contents. N represents a specific file chunk created during the split process.
AliasName—can be filled in if this is a duplicate of another contents file.
MinForDecode—Minimum number of file fragments needed for decoding
MaxDecodeCount—this can be the maximum number of file fragments created during erasure coding. If MaxDecodeCount is M one than files named GUID.N.0—(m-1). Contents are expected. MaxDecodeCount is always 5 for Metadata.
DownloadComplete—set to current date/time during the decoding process when enough information has been downloaded
DecodeComplete—set to current date/time during the decoding process
StitchComplete—set to current date/time during the stitch process
DecryptComplete—set to the current date/time during the decrypt process
DecompressComplete—set to current date/time during the decompress process
RestoreComplete—set to current date/time during the restore process

RestoreFilesToStoragePeers
RestoreFileId—foreign key to RestoreFiles
StoragePeerId—foreign key to StoragePeers

### StoragePeers

In an embodiment, a StoragePeers table can track information related to every peer the restore process encounters that have completed uploading files to the local machine or are\recently have been available to request files from. As the restore process runs it can update this table, inserting information returned from a call to the Control Server (GctOnlineStorageTargets exposed by the Restore Service) and/or removing information relating to peers that are no longer available to request files from. Information stored in this table is never removed once it has been altered from its initial state and/or is to be used as statistical data.
StoragePeerId—Primary Key
StorageName—the machine guid assigned by the system
IpAddress—The IP address used to communicate with a peer
Port—The port number used to communicate with a peer
RequestComplete—The date and/or time a peer accepted a request to restore files to local machine
DownloadComplete—The date and/or time a peer completed uploading files to local machine.

While various embodiments of the invention have been illustrated and described, many changes can be made in accordance with other embodiments of the present invention. Accordingly, the scope of the invention is not limited by the disclosure of any particular embodiment.

1. A method for providing a data protection service (DPS) with a DPS server over a network, comprising:
receiving a service request from a first client of the DPS server;
locating a plurality of clientele of the DPS server storing data associated with the first client, in response to the service request; and
facilitating direct transfer of the data from the plurality of clientele to the first client, such that each of the plurality of clientele transfers a portion of data associated with the first client.
